(19) United States
(12) Patent Application Publication
(10) Pub. No.: US 2010/0172080 A1
(43) Pub. Date: Jul. 8, 2010

(54) SCREEN ASSEMBLY

(75) Inventor: Nikolaj Bestle, Calabasas, CA (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/664,021

(22) PCT Filed: Jun. 14, 2007
(86) PCT No.: PCT/IB07/52261

§ 371 Date: Dec. 10, 2009

(51) Int. Cl. G06F 1/16; G06F 3/041

(52) U.S. Cl. 361/679.21; 345/173

(57) ABSTRACT

An assembly for a terminal device comprises a frame, a touch-sensitive input panel operable to detect the location of a haptic user input, a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and a switch operable to detect displacement of said panel relative to the frame resulting from said haptic user input.

### FIELD OF THE INVENTION

The present invention relates to an assembly for a terminal device, the assembly comprising a touch-sensitive panel.

### BACKGROUND

Conventionally, terminal devices such as mobile communications devices have been provided with a display for providing a user interface and displaying information, and a keypad for entering data.

It is becoming increasingly common for terminal devices to be provided with a touch-sensitive display. The touch-sensitive display can be provided in addition to, or instead of, a keypad. To enter information, the user presses on the relevant part of the display using their finger or a tool such as a stylus. In some devices, the user can also drag items or highlight areas on the display by stroking the display. It is known also to provide terminal devices with touch-sensitive panels which do not have a display function.

Currently available touch-sensitive input panels, particularly displays, often suffer from the problem that they do not always correctly register a user input. For example, the touch-sensitive input panel may be too sensitive, leading to an input when a user did not intend an input to be made, for instance when an accidental light touch of the input panel occurs. Also, a touch-sensitive input panel may not be sufficiently sensitive, in which case no input may be detected even if a user makes a contact which they believe should be deemed as an input.

In some devices, a short duration contact of a touch-sensitive input panel may not be detected, for instance due to operating system or display limitations.

Another disadvantage of a touch-sensitive input panel is that instant feedback may not be provided to the user when the display is pressed. For example, if a user enters information using a keypad, typically the key moves downward when the user presses it, and thus the user is assured that the entry of information has been registered. When the user presses on a conventional touch-sensitive input panel such as a display, the displayed information may not change immediately. In the absence of any other acknowledgement of data entry, the user would not know that the press had been registered and may continue to press the input panel. Ultimately, this may lead to frustration for the user.

It is an aim of the present invention to provide an assembly having a touch-sensitive input panel, e.g. a display, that can accurately register a haptic input from a user. It is a further aim of the present invention to provide tactile feedback to the user to indicate that the input of information has been registered.

### SUMMARY OF THE INVENTION

A first aspect of the present invention provides an assembly for a terminal device, the assembly comprising:
a frame;
a rigid touch-sensitive input panel operable to detect the location of a haptic user input;
a member pivotally connected to the frame to define two or more pivot axes and supporting the panel at locations distinct from the pivot axes, the member being arranged in such a way that the length of a part of the member connecting points on the two pivot axes varies in response to the haptic user input, and such that the panel is displaced relative to the frame as said length varies, and
a switch operable to detect displacement of said panel relative to the frame resulting from said haptic user input

A second aspect of the present invention provides an assembly comprising:
frame means;
touch-sensitive input means operable to detect the location of a haptic user input;
support means pivotally connected to the frame to define two or more pivot axes and supporting the input means at locations distinct from the pivot axes, the support means being arranged in such a way that the length of a part of the support means connecting points on the two pivot axes varies in response to the haptic user input, and such that the input means is displaced relative to the frame as said length varies, and
switch means operable to detect displacement of said input means relative to the frame resulting from said haptic user input.

Since the touch-sensitive input panel or means moves relative to the frame when the user provides a haptic input to the panel by pressing the panel, the user is provided with tactile feedback and thus can be immediately assured that their input has been registered. Furthermore, providing two pivot axes and a variable length member and supporting the panel at locations distinct from the pivot axes can allow the panel to have a particular motion in response to a user input of a given force independent of where the force of that user input is applied on the panel.

The switch may be coupled directly to said member so as to detect displacement of said member relative to the frame resulting from said haptic user input. Thus, the panel may not be directly coupled to the switch. This can provide the required functionality with a simple arrangement.

The member may comprise a plurality of rigid lever members linked to each other by a variable length connection. The lever members can be rectangular or can have another suitable shape, such as a “U” shape. The variable length joint may be a pin and slot joint.

The member may comprise two rigid lever members. The two rigid lever members may be substantially the same size. Thus, if the panel is supported centrally on the member, the displacement of the panel can be perpendicular to the plane of the panel.

The frame may comprise a base having four sidewalls to define a rectangular cavity, the member being pivotally connected to two opposing sidewalls of said four sidewalls.

### BRIEF DESCRIPTION OF THE DRAWINGS

Embodiments of the present invention will now be described by way of example only, with reference to the accompanying drawings in which:

FIG. 1A illustrates a cross section of a first embodied assembly, in the form of a display assembly, according to the present invention, in a first position;

FIG. 1B illustrates the FIG. 1A assembly in a second position;

FIG. 2A illustrates a cross section of a second embodied assembly, in the form of a display assembly, according to the present invention; and

FIG. 2B illustrates the FIG. 2A assembly in a second position.

In the Figures, reference numerals are re-used for like elements throughout.

### DETAILED DESCRIPTION OF EMBODIMENTS OF THE INVENTION

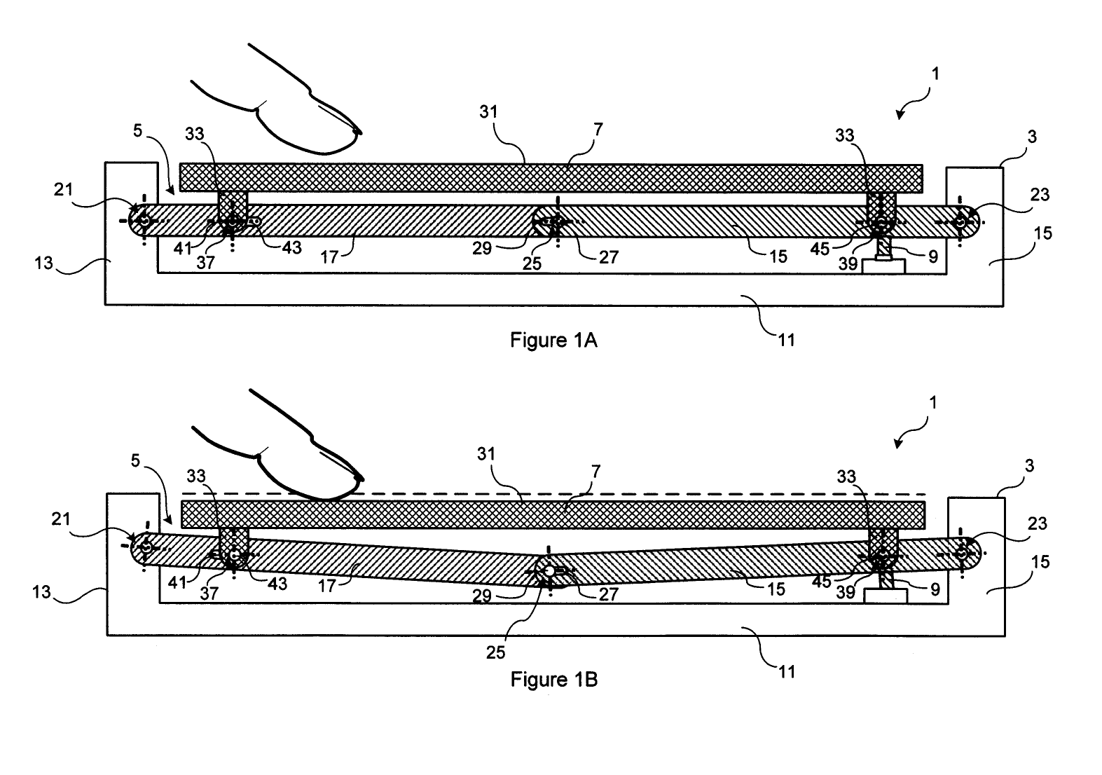

Referring firstly to FIGS. 1A and 1B, an assembly is a display assembly 1 and comprises a frame 3, a supporting member 5, a touch-sensitive display 7 and a switch 9. In this example, the display assembly 1 forms part of a mobile communications device (not shown).

The frame 3 has a base 11, a first sidewall 13 and a second sidewall 15 opposing the first sidewall 13. The frame 3 also has third and fourth sidewalls (not shown) perpendicular to the first and second sidewalls, to form a rectangular cavity for containing the supporting member 5, the display 7, and the switch 9.

The supporting member 5 comprises a first rigid lever member 17 and a second rigid lever member 19. The first and second lever members 17, 19 have a generally rectangular form with a length extending horizontally in the Figure and a width extending perpendicular to the plane of the Figure. In this example, the first and second rigid lever members 17, 19 are of equal length and each has a length slightly greater than the distance between the first sidewall 13 and the second sidewall 15.

The first rigid lever member 17 is pivotally connected at a first edge to the first sidewall 13 to define a first pivot axis 21. The second rigid lever member 19 is pivotally connected at a first edge to the second sidewall 15 to define a second pivot axis 23. These pivot connections can be provided by any suitable means. In this example, the pivot connections are provided by a pin and hole arrangement.

The first rigid lever member 17 and the second rigid lever member 19 are pivotally connected to each other at respective second edges, which are opposite to the first edges, to define a third pivot axis 25. The pivot connection is provided by a two pins 27 on the first lever member 17 threaded through two slots 29 on the second lever member 19 to form a pin and slot joint. Each pin 27 protrudes from the first lever member 17 near to and parallel to the second edge. Each slot 29 is provided near the second edge of the second lever member 19.

The display 7 has an upper surface 31 that is touch-sensitive. Thus, when a user provides a haptic user input to the upper surface 31 of the display 7, for example by touching the display 7 with a fingertip, the display 7 and associated circuitry (not shown) is operable to determine the location of the user input.

The display 7 is rectangular, and has dimensions slightly smaller than the rectangular cavity of the frame 3. The display 7 is not directly coupled to the frame 3. The display 7 is supported by the supporting member 5 to be parallel to the base 11 of the frame 3. This is achieved by four legs 33 (only two of which are shown in the Figures) each extending from the lower surface 35 of a corner of the display 7 to the supporting member 5. Preferably, each of the four legs 33 is equally spaced from its respective corner of the display 7. Preferably, the legs 33 are all equal in height.

Two of the legs 33 are pivotally connected to the first lever member 17 to define a fourth pivot axis 37. The pivot connection is provided by a pin 41 fixed to two of the legs 33, the pin 41 is threaded through respective slots 43 on the first lever member 17 to form a pin and slot joint. The other two of the legs 33 are pivotally connected to the second lever member 19 to define a fifth pivot axis 39. The pivot connection is provided by a pin 45 fixed to each of the legs 33. The pin 45 is threaded through respective holes (not shown) on the second lever member 19.

The distance between the fourth pivot axis 37 and the fifth pivot axis 39 is less than the distance between the first pivot axis 21 and the second pivot axis 23.

The switch 9 is an electromechanical switch. The switch 9 is operable to detect displacement of the display 7 relative to the frame 3. In this example, the switch 9 is coupled directly to the frame 3 and the second lever member 19, and detects displacement of the display relative to the frame 3 by detecting displacement of the second lever member 19 relative to the frame 3. The relationship between the displacement of the second lever member 19 and the displacement of the display 7 is described in further detail below.

Referring in particular to FIG. 1A, if there is no force applied to the display 7, the display assembly 1 is in a first position. In the first position, the supporting member 5 forms a straight line, i.e. the first lever member 17 and the second lever member 19 are parallel, and the display 7 is in a raised position. The switch 9 is open in the first position.

In this example, the supporting member 5 is held in a straight line position i.e. the lever members 17, 19 are not angled with respect to one another, by means of resilience in the switch 9. In other examples (not shown), the supporting member may be held in a straight line position by other means, for example by means of a compression spring coupled between the base 11 of the frame 3 and the third pivot point 25, or by means of resilience within the supporting member 5 itself.

Referring now to FIG. 1B, when a user presses the display 7 with a fingertip, or provides some other haptic input to the display 7, a force is applied via the legs 33 to the fourth pivot point 37 of the first lever member 17 and the fifth pivot point 39 on the second lever member 17. This results in a first moment being applied to the first lever member 17. This also results in a second moment being applied to the second lever member 19. This causes the first lever member 17 and the second lever member 19 to rotate such that their second edges move towards the base 11 of the frame 9. The pin and slot joint at the third pivot point 25 allows the length of the supporting member 5 to increase, thus allowing the supporting member 5 to form a shallow “V” shape.

As the fourth pivot axis 37 on the first lever member 17 and the fifth pivot axis 39 on the second lever member 19 move towards the base 11, the display 7 also moves towards the base 11. The difference in the distance between the fourth pivot axis 37 and the fifth pivot axis 39 in a direction parallel to the base is accounted for by the slot 43 on the fourth pivot axis 37. Movement of the display 7 towards the base 11 provides an immediate tactile feedback to the user that the input has been registered. The effect of the tactile feedback is increased by designing the arrangement such that the display 7 encounters sudden resistance to further movement once a certain travel of the display 7 has occurred. The resistance to further movement may be provided by the switch 9, or by some other component(s) of the arrangement.

Furthermore, as the fourth pivot axis 37 on the first lever member 17 and the fifth pivot axis 39 on the second lever member 19 move towards the base 11, the switch 9 is actuated by the second lever member 19. This indicates to associated circuitry (not shown) that the user has provided a haptic input to the display 7. The circuitry is responsive to this detection to sense the location of the haptic input on the display 7, using outputs of the display 7, and provide the location information to an operating system which manages operation of the host mobile communications device. The operating system can then provide appropriate signals to interested software applications. As the switch 9 is actuated before the location is sensed and a response is generated, the accuracy of detection of user inputs is improved.

The associated circuitry or the operating system may involve a timer, and the response may be dependent on the length of time that the switch 9 is actuated. For example, if the switch 9 is actuated by a user pressing the display 7 with a fingertip and the user then lifts their finger, returning the display assembly to the first position, before expiration of a first timer, a first response may be generated. The location of the haptic input is sensed in response to the detection of the release of the switch, and the first response is carried out. The first response may be opening by the operating system or an application of a new page that corresponds to an icon or text displayed at the detected location.

Alternatively, if the release of the switch does not occur until after the first timer expires, other actions may be taken. For example, if after the predetermined first amount of time the detected location of the fingertip on the upper surface 31 of the display has not changed, a second response may be generated. The second response may be displaying a menu by an application.

If the sensed location of the fingertip on the upper surface 31 of the display changes whilst the switch is actuated, the circuitry or operating system operates to monitor the location of the haptic input on the display until the switch is released. This allows e.g. selection of text on the display or dragging of items around the display.

In other examples, the location of the haptic input may be sensed before the switch 9 is actuated, but information on the detected location may only be captured, in the sense that the information is put to use, upon actuation of the switch 9.

In an alternative embodiment, the switch 9 is used as an alternative means for detecting a user input. In this embodiment, detection of actuation of the switch is used as described in any of the alternatives above for detecting the location(s) and nature of a haptic input. However, the touch sensitive display 7 also functions conventionally in the sense that it is able to determine without involvement what is the location (s) and nature of a haptic input. These two different techniques for detecting haptic input occur in parallel, i.e. a haptic input can be detected and acted on following actuation of the switch 9 even if the haptic input is not detected conventionally, or the haptic input can be detected and acted on conventionally even if the haptic input is not detected through actuation of the switch 9.

In other embodiments, the arrangement is used to react to user inputs differently. In particular, the arrangement is used in a two-stage input process hereafter termed ‘touch-click’. In touch-click, the location of a haptic user input is detected using the touch-sensitive display 7, and this input is used by the operating system and/or an application to highlight an icon or other item displayed at the appropriate location on the display. Subsequently actuation of the switch 9 is used by the operating system and/or application to activate whatever is denoted by the icon or item. To achieve this, a user merely needs to press the touch-sensitive display at the relevant location through detection by the touch-sensitive display until the switch is actuated, which the user can detect by way of the tactile feedback provided by the mechanism. Thus, two inputs can be achieved through a single movement, whereas in the corresponding prior art arrangement it would have been necessary to remove the stylus or finger between first and second touches of the touch-sensitive display.

It will be appreciated that the effectiveness of this mode of operation depends on the sensitivity of the display. To achieve the above-described operation, the touch-sensitive display needs to be sufficiently sensitive that it detects haptic user input before actuation of the switch. With a less sensitive touch-sensitive display, the same effect can be achieved but with actuation of the switch triggering a location sensing which results in highlighting of an icon or item followed by haptic input detection solely through the touch-sensitive display triggering activation of whatever is denoted by the icon or item.

The distance between the first pivot axis 21 and the fourth pivot axis 37 is equal to the distance between the second pivot axis 23 and the fifth pivot axis 39. Thus, irrespective of where the user presses on the display 7, an equal force will lead to a given rotation of the first and second lever members 17, 19. Therefore, an equal force is required to actuate the switch 9 regardless of where the force is applied on the display 7. Furthermore, since the first and second lever members 17, 19 are of substantially equal length, the display 7 moves parallel to the base 11 of the frame 3 when a force is applied.

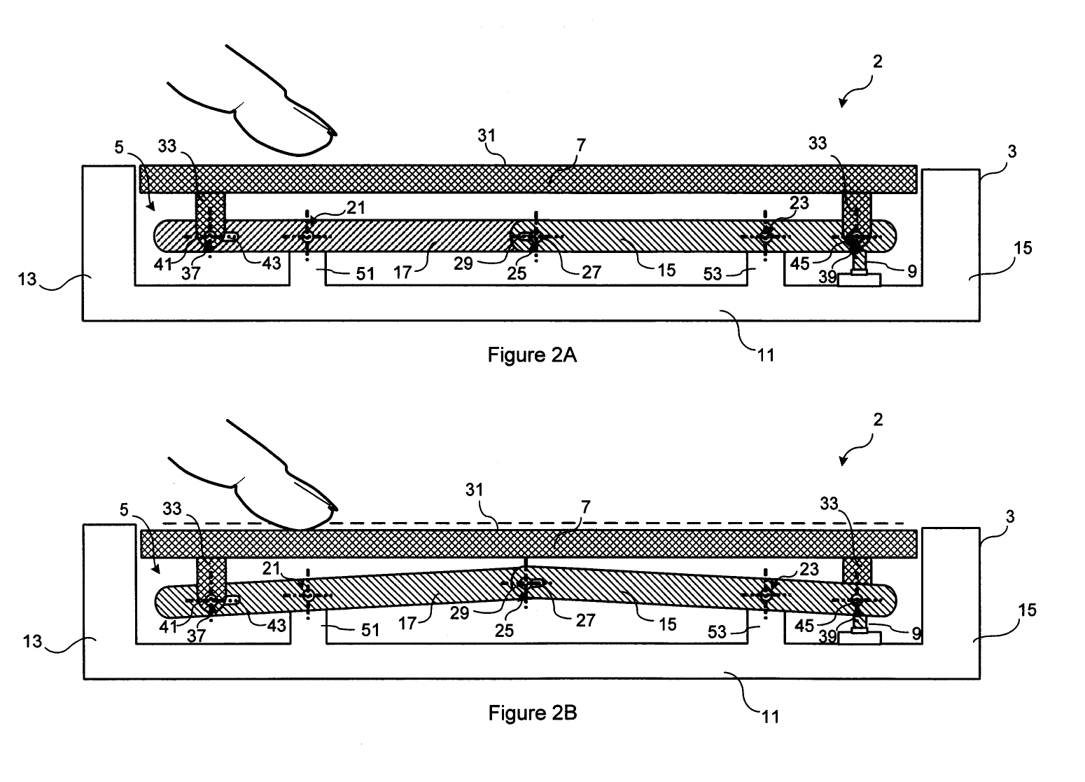

Referring now to FIG. 2A and FIG. 2B, a second embodied assembly, in the form of a display assembly 2, also comprises a frame 3, a supporting member 5, a touch-sensitive display 7 and a switch 9.

The frame 3 has a base 11, a first sidewall 13 and a second sidewall 15 opposing the first sidewall 13. The frame 3 also has third and fourth sidewalls (not shown) perpendicular to the first and second sidewalls, to form a rectangular cavity for containing the supporting member 5, the display 7, and the switch 9. The frame 3 also comprises a first support 51 and a second support 53 upstanding from the base 11 inside the rectangular cavity. The first support 51 and the second support 53 are arranged to support the supporting member 5 as described below.

The supporting member 5 has substantially the same structure as described with reference to the FIG. 1A display assembly 1. However, in this embodiment the first lever member 17 and the second lever member 19 are not pivotally connected to the first wall 13 and the second wall 15 respectively of the frame 3. Instead, the first lever member 17 is pivotally connected to the first arm 51 to define the first pivot axis 21 and the second lever member 19 is pivotally connected to the second arm 53 to define the second pivot axis 23.

The display 7 and the switch 9 have substantially the same structure as described with reference to the FIG. 1A display assembly 1. In this embodiment, the distance between the fourth pivot axis 37 and the fifth pivot axis 39 is greater than the distance between the first pivot axis 21 and the second pivot axis 23.

Referring in particular to FIG. 2A, if there is no force applied to the display 7, the display assembly 2 is in a first position. In the first position, the supporting member 5 forms a straight line, i.e. the first lever member 17 and the second lever member 19 are parallel, and the display 7 is in a raised position. The switch 9 is open in the first position.

Referring now to FIG. 2B, when a user presses the display 7 with a fingertip, or provides some other haptic input to the display 7, a force is applied via the legs 33 to the fourth pivot point 37 of the first lever member 17 and the fifth pivot point 39 on the second lever member 17. As described with reference to the FIG. 1B display assembly, this causes the first lever member 17 and the second lever member 19 to rotate. Since, in this example, the force is applied on the opposite sides to the first and second pivot axes 21, 23, this causes the first lever member 17 and the second lever member 19 to rotate in the opposite direction i.e. the first lever member 17 and the second lever member 19 rotate such that their second edges move away from the base 11.

This rotation also causes the first edges of the first and second lever members 17, 19 to move towards the base 11. Thus the display 11 moves towards the base, and the switch 9 is actuated by the second lever member 19. Therefore, the second embodied display assembly 2 behaves similarly to the first embodied display assembly 1 in response to a haptic user input.

In the above described examples, the supporting member 5 comprises two rectangular rigid lever members 17, 19 linked by a pin and slot joint. In other examples, the supporting member 5 can have a different structure, provided that it is arranged to have a variable length such that it can be deformed to allow the display 7 to move relative to the frame 3 in response to a haptic user input. For example, the lever members 15, 17 may be replaced by components which provide the same or similar function. The first and second components may each have a “U” shape in the plane of the lever members 15, 17. The “U” shape of the first component may be formed by two rectangular limbs perpendicular to the first pivot axis 21 joined by a base having an axis coinciding with the first pivot axis 21. Similarly, the “U” shape of the second component may be formed by two rectangular limbs perpendicular to the second pivot axis 23 joined by a base in line with the second pivot axis 23. Thus, when linked together, the U shaped component form a supporting member in the shape of a rectangle with a central rectangular hole. This structure can allow circuitry, or other components, to be placed in the same plane as the supporting member 5.

In yet another example, the supporting member 5 may comprise three rigid components also linked by pin and slot joints. Alternatively, the rigid components may be linked by means of an expansion spring. The supporting member 5 may also comprise a resilient material.

In the above described examples, the switch 9 is provided between the base 11 of the frame 3 and the second lever member 19. In other examples, the position of the switch 9 may vary, provided that it is arranged to detect displacement of the display 7 relative to the frame either directly or indirectly. For example, the switch may be coupled directly between the display 7 and the frame 3, or may be coupled between the first lever member 17 and the frame 3.

The frame 3 may not be provided with a rectangular cavity having a base 11 and sidewalls 13, 15 as described above. The frame 3 can have any structure that appropriately supports the supporting member 5 and the switch 9.

The invention is applicable also to non-display input arrangements. In a further embodiment of the invention (not shown in the Figures), an assembly comprises an arrangement substantially as shown in FIGS. 1A and 1B. In place of the display 7 of those Figures, however, a non-display panel is used. The panel comprises a rigid component with a planar upper surface having touch sensitivity. As with the touch-sensitive display of the FIGS. 1A and 1B embodiment, the panel provides output signals from which the location of a haptic user input can be determined. The panel may be provided with pre-printed graphics, for instance denoting the function of keys (direction arrows, numbers, call function keys etc.) which relate to the corresponding area of the panel. The functions provided by user input at the relevant locations on the panel may not change, unlike the touch-sensitive display embodiments.

In a further embodiment (not shown), an assembly comprises an arrangement substantially as shown in FIGS. 2A and 2B, although the display thereof is replaced with a panel having a rigid component with a planar upper surface with touch sensitivity.

In a still further embodiment (not shown), a touch-sensitive panel comprising at least one display part and at least one non-display part is used in place of the display 7 of FIG. 1 or FIG. 2.

Each of these unshown embodiments incorporates the relevant apparatus and operational features from the FIGS. 1 and 2 embodiments and experiences all the advantages thereof. Of course, the resolution (in terms of the resolution of location of a haptic user input) of a non-display touch-sensitive input panel might be significantly lower than the resolution of a touch-sensitive display.

It should be realised that the foregoing examples should not be construed as limiting. Other variations and modifications will be apparent to persons skilled in the art upon reading the present application. Such variations and modifications extend to features already known in the field, which are suitable for replacing the features described herein, and all functionally equivalent features thereof. Moreover, the disclosure of the present application should be understood to include any novel features or any novel combination of features either explicitly or implicitly disclosed herein or any generalisation thereof and during the prosecution of the present application or of any application derived therefrom, new claims may be formulated to cover any such features and/or combination of such features.

1. An assembly, comprising:
a frame;
a touch-sensitive input panel operable to detect the location of a haptic user input;
a member pivotally connected to the frame to define two or more pivot axes and to support the touch-sensitive input panel at locations distinct from the pivot axes, the member being arranged in such a way that the length of a part of the member connecting points on the two pivot axes varies in response to the haptic user input, and such that the touch-sensitive input panel is displaced relative to the frame as the length varies;
and a switch operable to detect displacement of the touch-sensitive input panel relative to the frame resulting from the haptic user input.

2. An assembly as claimed in claim 1, wherein the switch is coupled directly to the member so as to detect displacement of the member relative to the frame resulting from the haptic user input.

3. An assembly as claimed in claim 1, wherein the member comprises a plurality of rigid lever members linked to each other by a variable length connection.

4. An assembly as claimed in claim 1, wherein the member comprises a plurality of rigid components pivotally connected to the frame by a variable length connection.

5. An assembly as claimed in claim 3, wherein the variable length joint is a pin and slot joint.

6. An assembly as claimed in claim 3, wherein the member comprises two rigid components.

7. An assembly as claimed claim 6, wherein the two rigid components are substantially the same size.

8. An assembly as claimed in claim 1, wherein the member is resilient.

9. An assembly as claimed in claim 1, wherein the frame comprises
a base having four sidewalls to define a rectangular cavity, the member being pivotally connected to two opposing sidewalls of the four sidewalls.

10. An assembly as claimed in claim 1, wherein the switch is an electromechanical switch.

11. An assembly as claimed in claim 1, wherein the touch-sensitive input panel is a touchsensitive display panel.

12. An assembly comprising:
frame means;
touch-sensitive input means operable to detect the location of a haptic user input;
support means pivotally connected to the frame to define two or more pivot axes and supporting the input means at locations distinct from the pivot axes, the support means being arranged in such a way that the length of a part of the support means connecting points on the two pivot axes varies in response to the haptic user input, and such that the input means is displaced relative to the frame as the length varies, and
switch means operable to detect displacement of the input means relative to the frame resulting from the haptic user input.

13. An assembly as claimed in claim 12, wherein the switch means is coupled directly to the support means so as to detect displacement of the support means relative to the frame means resulting from the haptic user input.

14. An assembly as claimed in claim 12, wherein the support means comprises a plurality of rigid lever members linked to each other by a variable length connection.

15. An assembly as claimed in claim 12, wherein the support means comprises a plurality of rigid components pivotally connected to the frame means by a variable length connection.

16. An assembly as claimed in claim 14, wherein the variable length joint is a pin and slot joint.

17. An assembly as claimed in claim 14, wherein the support means comprises two rigid components.

18. An assembly as claimed in claim 17, wherein the two rigid components are substantially the same size.

19. An assembly as claimed in claim 12, wherein the support means is resilient.

20. An assembly as claimed in claim 12, wherein the frame means comprises a base means having four sidewalls to define a rectangular cavity, the support means being pivotally connected to two opposing sidewalls of the four sidewalls.

21-22. (canceled)
